(19) United States
(12) Patent Application Publication
(10) Pub. No.: US 2025/0316690 A1
(43) Pub. Date: Oct. 9, 2025

(54) POSITIVE ELECTRODE ACTIVE MATERIAL FOR SECONDARY BATTERY, POSITIVE ELECTRODE FOR SECONDARY BATTERY, AND SECONDARY BATTERY

(71) Applicant: MURATA MANUFACTURING CO., LTD., Kyoto (JP)

(72) Inventor: Kei HASEGAWA, Kyoto (JP)

(21) Appl. No.: 19/246,371

(22) Filed: Jun. 23, 2025

Related U.S. Application Data
(63) Continuation of application No. PCT/JP2023/043830, filed on Dec. 7, 2023.

(30) Foreign Application Priority Data
Jan. 27, 2023 (JP) 2023-010914

(51) Int. Cl. H01M 4/36; H01M 4/02; H01M 4/131; H01M 4/525; H01M 10/0525

(52) U.S. Cl. CPC H01M 4/366; H01M 4/131; H01M 4/525; H01M 10/0525; H01M 2004/028

(57) ABSTRACT

A secondary battery includes a positive electrode, a negative electrode, and an electrolytic solution. The positive electrode includes a positive electrode active material. The positive electrode active material includes a center part, and a covering part covering a surface of the center part. The center part includes a first lithium composite oxide having a layered rock-salt crystal structure. The covering part includes a second lithium composite oxide. The second lithium composite oxide has an orthorhombic crystal structure represented by space group Immm and includes nickel as a constituent element.

### CROSS REFERENCE TO RELATED APPLICATIONS

The present application is a continuation of International Patent Application No. PCT/JP2023/043830, filed on Dec. 7, 2023, which claims priority to Japanese Patent Application No. 2023-010914, filed on Jan. 27, 2023, the entire contents of which are incorporated herein by reference.

### BACKGROUND

The present technology relates to a positive electrode active material for a secondary battery, to a positive electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode (a positive electrode active material for a secondary battery and a positive electrode for a secondary battery), a negative electrode, and an electrolytic solution. A configuration of the secondary battery has been considered in various ways.

Specifically, a composite positive electrode active material includes a secondary particle and a coating film, the secondary particle includes a lithium-transition-metal oxide having a layered crystal structure, and the coating film includes a lithium-cobalt composite oxide having a spinel crystal structure. A positive electrode active material layer includes a positive electrode active material and a covering layer, and the covering layer has a resistivity within a predetermined range.

A positive electrode active material sintered body includes a powdered main body and a covering layer, the powdered main body includes a lithium composite oxide, and the covering layer includes an amorphous lithium-transition-metal oxide. An electrode active material includes a lithium-nickel composite oxide and a lithium-transition-metal-M composite oxide, and a surface of the lithium-nickel composite oxide is coated with the lithium-transition-metal-M composite oxide.

### SUMMARY

The present technology relates to a positive electrode active material for a secondary battery, to a positive electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a positive electrode active material for a secondary battery, a positive electrode for a secondary battery, and a secondary battery that each make it possible to achieve a superior battery characteristic.

A positive electrode active material for a secondary battery according to an embodiment of the present technology includes a positive electrode active material. The positive electrode active material includes a center part and a covering part. The covering part covers a surface of the center part. The center part includes a first lithium composite oxide having a layered rock-salt crystal structure. The covering part includes a second lithium composite oxide. The second lithium composite oxide has an orthorhombic crystal structure represented by space group Immm and includes nickel as a constituent element.

A positive electrode for a secondary battery according to an embodiment of the present technology includes a positive electrode active material. The positive electrode active material has a configuration similar to the above-described configuration of the positive electrode active material for the secondary battery according to an embodiment of the present technology.

A secondary battery according to an embodiment of the present technology includes a positive electrode, a negative electrode, and an electrolytic solution. The positive electrode has a configuration similar to the above-described configuration of the positive electrode for the secondary battery according to an embodiment of the present technology.

According to the positive electrode active material for the secondary battery, the positive electrode for the secondary battery, or the secondary battery of an embodiment of the present technology, the positive electrode active material for the secondary battery includes the center part and the covering part. The center part includes the first lithium composite oxide having the layered rock-salt crystal structure. The covering part includes the second lithium composite oxide. The second lithium composite oxide has the orthorhombic crystal structure represented by space group Immm and includes nickel as a constituent element. This makes it possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a sectional diagram illustrating a configuration of a positive electrode active material for a secondary battery according to an embodiment of the present technology.

FIG. 2 is a perspective diagram illustrating a configuration of a secondary battery according to an embodiment of the present technology.

FIG. 3 is a sectional diagram illustrating, in an enlarged manner, a configuration of a battery device illustrated in FIG. 2.

FIG. 4 is a block diagram illustrating a configuration of an application example of the secondary battery.

FIG. 5 is a sectional diagram illustrating a configuration of a test secondary battery.

### DETAILED DESCRIPTION

The present technology is described below in further detail including with reference to the drawings according to an embodiment.

A description is given first of a positive electrode active material for a secondary battery according to an embodiment of the present technology. Hereinafter, the positive electrode active material for the secondary battery is simply referred to as the “positive electrode active material”.

The positive electrode active material to be described here is to be used in a secondary battery, which is an electrochemical device. However, the positive electrode active material may be used in electrochemical devices other than the secondary battery. Specific examples of the other electrochemical devices include a primary battery and a capacitor.

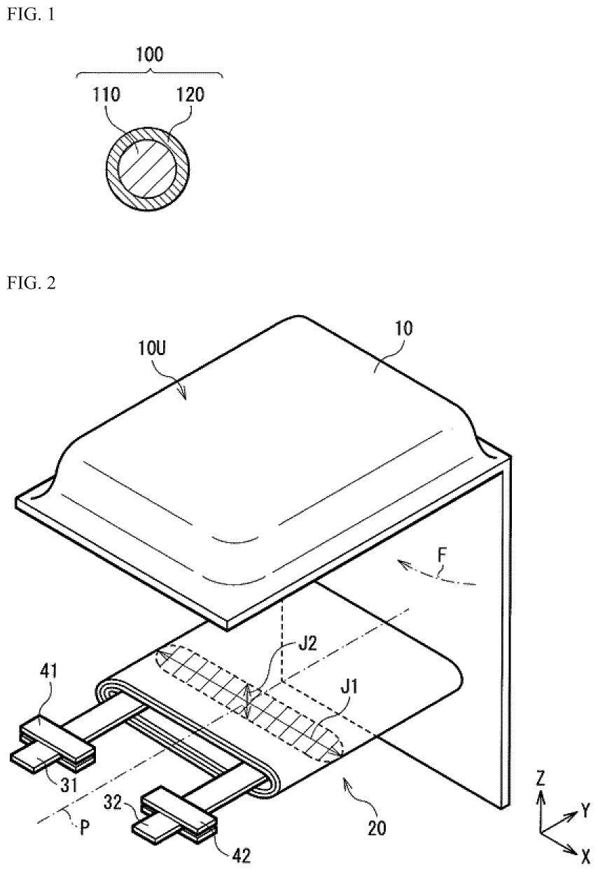

FIG. 1 illustrates a sectional configuration of a positive electrode active material 100 as an example of the positive electrode active material. The positive electrode active material 100 includes multiple positive electrode active materials 100 that are in particle form and each allow lithium to be inserted thereinto and extracted therefrom. The positive electrode active materials 100 each include a center part 110 and a covering part 120, as illustrated in FIG. 1. Note that FIG. 1 illustrates only one positive electrode active material 100.

The center part 110 is a part which lithium is to be substantially inserted into and extracted from. The center part 110 includes any one or more of first lithium composite oxides.

The first lithium composite oxide is an oxide including lithium and one or more of transition metal elements as constituent elements, and has a layered rock-salt crystal structure. The one or more transition metal elements are not particularly limited in kind, and specific examples thereof include nickel, cobalt, and manganese.

Note that the first lithium composite oxide may further include, as one or more constituent elements, any one or more of metal elements other than the transition metal elements. Hereinafter, the metal elements other than the transition metal elements are each referred to as a “first additional metal element”. The first additional metal element is not particularly limited in kind, and specific examples thereof include aluminum and magnesium.

Specific examples of the first lithium composite oxide include LiNiO₂, LiCoO₂, Li_{1.02}Ni_{0.90}Co_{0.05}Al_{0.05}O₂, LiCo_{0.98}Al_{0.01}Mg_{0.01}O₂, LiNi_{0.5}Co_{0.2}Mn_{0.3}O₂, and LiMn₂O₄.

One reason why the center part 110 includes the first lithium composite oxide is that this allows a sufficient amount of lithium to be inserted into and extracted from the center part 110, and thus makes it possible to obtain a high battery capacity in the secondary battery including the positive electrode active material 100.

The crystal structure of the first lithium composite oxide is identifiable by analyzing the first lithium composite oxide by an analysis method such as powder X-ray diffractometry. In this case, copper is used as an X-ray target, a temperature of an analysis environment is set to a room temperature of 23° C., a measurement range (2θ) is set to a range from 10° to 80° both inclusive, and a step operation is set to 0.01°/sec. In addition, the crystal structure that matches the measurement result in terms of conditions including, without limitation, a surface spacing of a peak, an intensity ratio of the peak, a crystal system, and a lattice constant is identified (database: Li2NiO2 ICSD No. 25000). Such identification of the crystal structure is performed by referring to material database to analyze a measurement chart, and by searching for the crystal structure, based on a surface spacing d calculated from the measurement result (a value of 2θ).

The composition of the first lithium composite oxide is identifiable by analyzing the first lithium composite oxide by an analysis method such as inductively coupled plasma (ICP) optical emission spectroscopy. In this analysis, the composition of the first lithium composite oxide is identified because lithium, the transition metal element, and the first additional metal element are quantified. In this case, the first lithium composite oxide is analyzed by decomposing the first lithium composite oxide into a solution by a microwave digestion method.

The covering part 120 is a part that covers the center part 110. The covering part 120 includes any one or more of second lithium composite oxides.

The covering part 120 may cover all of a surface of the center part 110, or may cover only a part of the surface of the center part 110. In the latter case, multiple covering parts 120 may cover the surface of the center part 110 at respective locations separate from each other.

The second lithium composite oxide is an oxide including lithium and nickel as constituent elements. The second lithium composite oxide has an orthorhombic crystal structure represented by space group Immm, unlike the first lithium composite oxide described above.

The second lithium composite oxide may further include, as one or more constituent elements, any one or more of metal elements other than nickel. Hereinafter, the above-described metal elements other than nickel are each referred to as a “second additional metal element”. The second additional metal element may be a transition metal element, or may be a metal element other than the transition metal element. The second additional metal element is not particularly limited in kind, and specific examples thereof include titanium, platinum, copper, and tungsten.

Specifically, the second lithium composite oxide includes any one or more of compounds represented by Formula (1).

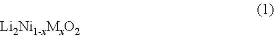

where:
M includes at least one of Ti, Pt, Cu, or W; and
x satisfies 0≤x≤0.25.

As can be seen from Formula (1), the second lithium composite oxide is an oxide including lithium and nickel as constituent elements. As is apparent from the range of x, the second lithium composite oxide may include a second metal element M as a constituent element, or may include no second metal element M as a constituent element.

Specific examples of the second lithium composite oxide include Li₂NiO₂, Li₂Ni_{0.99}Ti_{0.01}O₂, Li₂Ni_{0.75}Ti_{0.25}O₂, Li₂Ni_{0.75}Pt_{0.25}O₂, Li₂Ni_{0.75}Cu_{0.25}O₂, and Li₂Ni_{0.75}W_{0.25}O₂.

One reason why the covering part 120 includes the second lithium composite oxide is that this allows the surface of the center part 110 that is highly reactive to be electrochemically protected by the covering part 120. Accordingly, in the secondary battery including the positive electrode active material 100, a decomposition reaction of the electrolytic solution on the surface of the center part 110 is suppressed. This suppresses an increase in electrical resistance and suppresses a decrease in discharge capacity even when the secondary battery is repeatedly charged and discharged.

In particular, the second additional metal element M preferably includes Cu, W, or both as one or more constituent elements. One reason for this is that this further suppresses an increase in electrical resistance when the secondary battery is repeatedly charged and discharged.

Alternatively, the second additional metal element M preferably includes any one or more of Ti, Pt, or Cu as one or more constituent elements. One reason for this is that this further suppresses a decrease in discharge capacity when the secondary battery is repeatedly charged and discharged.

Although not particularly limited, an average covering amount of the covering part 120 is preferably within a range from 0.01 mmol/m² to 0.05 mmol/m² both inclusive, in particular. One reason for this is that this allows a covered state in which the surface of the center part 110 is covered by the covering part 120 to be appropriate, and thus allows the surface of the center part 110 to be electrochemically protected by the covering part 120 sufficiently. This sufficiently suppresses the decomposition reaction of the electrolytic solution, which sufficiently suppresses an increase in electrical resistance and sufficiently suppresses a decrease in discharge capacity.

A forming method of the covering part 120, that is, a method of covering the surface of the center part 110 with a material to be included in the covering part 120 is not particularly limited, and may be selected as desired. Hereinafter, the material to be included in the covering part 120 is referred to as a “covering material”.

For example, the covering part 120 is formed by a dry coating method. In the dry coating method, the covering material adheres to the surface of the center part 110 while being grinded by using shearing force. The covering material is thus fixed to the surface of the center part 110, and the covering part 120 is thus formed. Note that when the covering material is melted by thermal energy and is plastically deformed by mechanical energy, the covering material becomes a thin film that covers the surface of the center part 110.

The crystal structure of the second lithium composite oxide is identifiable by analyzing the second lithium composite oxide by an analysis method such as X-ray absorption spectroscopy (XAS). When the XAS is used as the analysis method, the crystal structure of the second lithium composite oxide is identified by analyzing the crystal structure of the second lithium composite oxide, based on an X-ray absorption near-edge structure (XANES), using a first-principles calculation program (FEFF) for an X-ray absorption spectrum. The XANES is a microstructure to be detected at an absorption near-edge (within a range in which energy E is about ±50 eV with respect to a position of an absorption edge) in the X-ray absorption spectrum.

A procedure for identifying the composition of the second lithium composite oxide is similar to the procedure for identifying the composition of the first lithium composite oxide. Note that, however, in the procedure for identifying the composition of the second lithium composite oxide, the second additional metal element is quantified, instead of the first additional metal element.

Further, a procedure for calculating the average covering amount of the covering part 120 is as described below. The following description deals with a case where the second lithium composite oxide includes the second additional metal element as a constituent element.

First, the covering part 120 is analyzed by the ICP optical emission spectrometry to thereby measure a content (g/m²) of the second additional metal element included in the second lithium composite oxide as a constituent element. Thereafter, an atomic weight of the second additional metal element is identified. For example, when the second additional metal element is titanium (atomic number 22), the atomic weight of the second additional metal element is 47.867. Thereafter, the covering amount (mmol/m²) is calculated based on the following calculation expression: covering amount=content of second additional metal element/atomic weight of second additional metal element. Lastly, the process of calculating the covering amount is repeated ten times while changing a position of the covering part 120 to be analyzed, to thereby calculate ten covering amounts, following which an average value of the ten covering amounts is calculated. The calculated average value is regarded as the average covering amount.

The positive electrode active material 100 is manufactured by the following example procedure.

First, a raw material for forming the covering material is prepared. The raw material is a compound including nickel as a constituent element, and may further include the second additional metal element as a constituent element. The raw material is not particularly limited in kind, and specific examples thereof include a carbonic acid salt and a hydroxide.

Thereafter, the raw material is fired to thereby form a precursor body for forming the covering material. The precursor body is an oxide including nickel as a constituent element, and may further include the second additional metal element as a constituent element, as described above. Note that firing conditions including, without limitation, a firing temperature and a firing time may be set as desired.

Lastly, the covering material is formed through a solid phase reaction.

Specifically, the precursor body and a lithium compound are mixed with each other to thereby obtain a mixture, following which the mixture is fired to thereby obtain a fired material. The lithium compound is a compound including lithium as a constituent element. The lithium compound is not particularly limited in kind, and is specifically, for example, an oxide or a hydroxide. Note that firing conditions including, without limitation, a firing temperature and a firing time may be set as desired.

Thereafter, the fired material is pulverized to thereby obtain a pulverized material, following which coarse particles are removed from the pulverized material with a sieve. In this case, a pulverizing tool such as a mortar is used. A mesh size (um) of the sieve is not particularly limited, and may be set as desired.

The covering material in powder form as the pulverized material is thus obtained. The covering material includes the second lithium composite oxide having the orthorhombic crystal structure represented by the space group Immm.

In this case, the crystal structure of the covering material (the second lithium composite oxide) is adjusted to be the orthorhombic crystal structure represented by the space group Immm, by adjusting the firing conditions at the time of firing the mixture of the precursor body and the lithium compound.

Thereafter, multiple center parts 110 in powder form are prepared. The center parts 110 each include the first lithium composite oxide having a layered rock-salt crystal structure.

Lastly, granulation is performed using the center parts 110 and the covering material. In this case, a granulation apparatus such as a centrifugal fluidized granulator is used. Note that granulation conditions including, without limitation, a granulation temperature and a granulation time may be set as desired.

The covering material is thereby fixed to the surface of each of the center parts 110, and the covering part 120 is thus formed. As a result, multiple positive electrode active materials 100 each including the center part 110 and the covering part 120 are completed.

In this case, the average covering amount of the covering part 120 is adjustable by adjusting an amount of the covering material to be put in when the granulation is performed using the center parts 110 and the covering material.

According to the positive electrode active material 100, the positive electrode active material 100 includes the center part 110 and the covering part 120. The center part 110 includes the first lithium composite oxide having the layered rock-salt crystal structure. The covering part 120 includes the second lithium composite oxide. The second lithium composite oxide has the orthorhombic crystal structure represented by the space group Immm and includes nickel as a constituent element.

In this case, because the center part 110 includes the first lithium composite oxide, a sufficient amount of lithium is inserted into and extracted from the center part 110, as described above. Therefore, a high battery capacity is obtainable in the secondary battery including the positive electrode active material 100.

In addition, because the covering part 120 includes the second lithium composite oxide, the surface of the center part 110 that is highly reactive is electrochemically protected by the covering part 120, as described above. This suppresses the decomposition reaction of the electrolytic solution on the surface of the center part 110 in the secondary battery including the positive electrode active material 100. Accordingly, even if the secondary battery is repeatedly charged and discharged, an increase in electrical resistance is suppressed and a decrease in discharge capacity is suppressed.

For the above-described reasons, in the secondary battery including the positive electrode active material 100, a high battery capacity is obtained, and an increase in electrical resistance and a decrease in discharge capacity is suppressed even if the secondary battery is repeatedly charged and discharged. Accordingly, it is possible to obtain a secondary battery having a superior battery characteristic by using the positive electrode active material 100.

In particular, the second lithium composite oxide may include the compound represented by Formula (1). This allows the surface of the center part 110 to be electrochemically protected by the covering part 120 sufficiently, and thus allows the decomposition reaction of the electrolytic solution to be suppressed sufficiently. Such sufficient suppression of the decomposition reaction of the electrolytic solution sufficiently suppresses an increase in electrical resistance and sufficiently suppresses a decrease in discharge capacity. Accordingly, it is possible to achieve higher effects.

In this case, the second additional metal element M may include Cu, W, or both as one or two constituent elements. This further suppresses an increase in electrical resistance. Accordingly, it is possible to achieve even higher effects. Alternatively, the second additional metal element M may include one or more of Ti, Pt, or Cu as one or more constituent elements. This further suppresses a decrease in discharge capacity. Accordingly, it is possible to achieve even higher effects.

Further, the average covering amount of the covering part 120 may be within the range from 0.01 mmol/m² to 0.05 mmol/m² both inclusive. This allows the surface of the center part 110 to be electrochemically protected by the covering part 120 sufficiently, and thus allows the decomposition reaction of the electrolytic solution to be suppressed sufficiently. Such sufficient suppression of the decomposition reaction of the electrolytic solution sufficiently suppresses an increase in electrical resistance and sufficiently suppresses a decrease in discharge capacity. Accordingly, it is possible to achieve higher effects.

Next, a description is given of a secondary battery of an embodiment of the present technology to which the positive electrode active material 100 is to be applied.

Note that a positive electrode for a secondary battery according to an embodiment of the present technology is a component of the secondary battery to be described here, and is thus described below together. Hereinafter, the positive electrode for the secondary battery is simply referred to as the “positive electrode”.

The secondary battery is a secondary battery in which a battery capacity is obtained through insertion and extraction of an electrode reactant, and includes a positive electrode, a negative electrode, and an electrolytic solution. More specifically, a secondary battery in which the battery capacity is obtained through insertion and extraction of lithium is what is called a lithium-ion secondary battery. In the lithium-ion secondary battery, lithium is inserted and extracted in an ionic state.

Note that a charge capacity of the negative electrode is preferably greater than a discharge capacity of the positive electrode. In other words, an electrochemical capacity per unit area of the negative electrode is preferably greater than an electrochemical capacity per unit area of the positive electrode. This is to prevent precipitation of lithium on a surface of the negative electrode during charging.

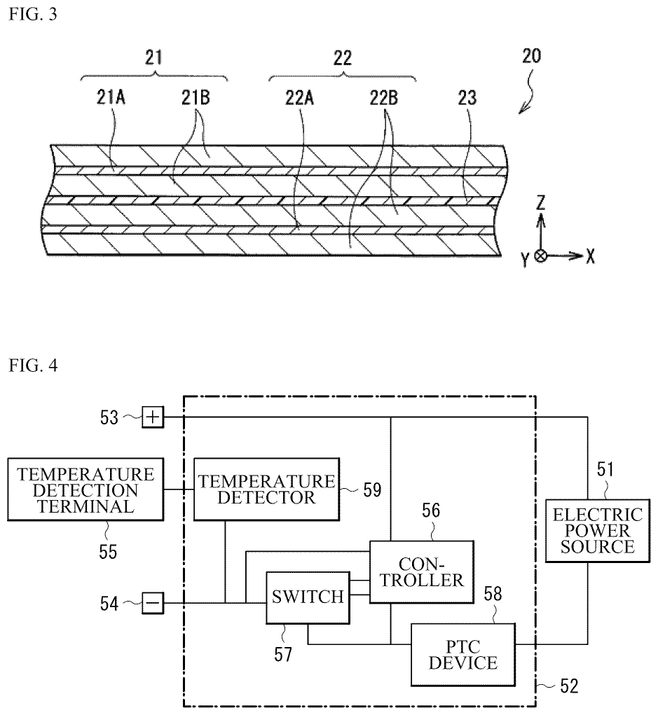

FIG. 2 illustrates a perspective configuration of the secondary battery. FIG. 3 illustrates, in an enlarged manner, a sectional configuration of a battery device 20 illustrated in FIG. 2. Note that FIG. 2 illustrates a state in which an outer package film 10 and the battery device 20 are separated from each other, and illustrates a section of the battery device 20 along an XZ plane by a dashed line.

As illustrated in FIGS. 2 and 3, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 2, the outer package film 10 is an outer package member that contains the battery device 20. The outer package film 10 has a pouch-shaped structure that is sealed in a state in which the battery device 20 is contained inside the outer package film 10. The outer package film 10 thus contains a positive electrode 21, a negative electrode 22, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10, which is a laminated film, is not particularly limited in configuration or the number of layers, and may be single-layered or two-layered, or may include four or more layers.

As illustrated in FIGS. 2 and 3, the battery device 20 is a power generation device that includes the positive electrode 21, the negative electrode 22, a separator 23, and the electrolytic solution (not illustrated). The battery device 20 is contained inside the outer package film 10.

The battery device 20 is what is called a wound electrode body. That is, the positive electrode 21 and the negative electrode 22 are wound about a winding axis P, being opposed to each other with the separator 23 interposed therebetween. The winding axis P is a virtual axis extending in a Y-axis direction.

The battery device 20 is not particularly limited in three-dimensional shape. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 3, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials which lithium is to be inserted into and extracted from. Note that the positive electrode active material layer 21B may further include any one or more of other materials. Examples of the other materials include a positive electrode binder and a positive electrode conductor. A method of forming the positive electrode active material layer 21B is not particularly limited, and specifically includes a method such as a coating method.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22.

The positive electrode active material has a configuration similar to that of the positive electrode active material 100. Details of the configuration of the positive electrode active material 100 are as described above.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The negative electrode 22 includes, as illustrated in FIG. 3, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials which lithium is to be inserted into and extracted from. Note that the negative electrode active material layer 22B may further include any one or more of other materials. Examples of the other materials include a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that a high energy density is obtainable.

Specific examples of the carbon material include graphitizable carbon, non-graphitizable carbon, and graphite (natural graphite and artificial graphite).

The metal-based material is a material including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 3, and allows lithium ions to pass therethrough while preventing contact (a short circuit) between the positive electrode 21 and the negative electrode 22. The separator 23 includes a polymer compound such as polyethylene.

The electrolytic solution is a liquid electrolyte. The positive electrode 21, the negative electrode 22, and the separator 23 are impregnated with the electrolytic solution. The electrolytic solution includes a solvent and an electrolyte salt.

Here, the solvent includes any one or more of non-aqueous solvents (organic solvents), and the electrolytic solution including the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example. One reason for this is that a dissociation property of the electrolyte salt improves and ion mobility also improves.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate. The lactone-based compound is, for example, a lactone. Specific examples of the lactone include γ-butyrolactone and γ-valerolactone. Note that the ether may be, for example, 1,2-dimethoxyethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis (fluorosulfonyl) imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

Note that the electrolytic solution may further include any one or more of additives. One reason for this is that electrochemical stability of the electrolytic solution improves. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

As illustrated in FIGS. 2 and 3, the positive electrode lead 31 is a positive electrode terminal coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 is not particularly limited in shape, and specifically has any of shapes including, without limitation, a thin plate shape and a meshed shape.

As illustrated in FIGS. 2 and 3, the negative electrode lead 32 is a negative electrode terminal coupled to the negative electrode current collector 22A of the negative electrode 22, and is led to the outside of the outer package film 10. The negative electrode lead 32 includes an electrically conductive material such as a metal material. Specific examples of the electrically conductive material include copper. Details of a direction in which the negative electrode lead 32 is led are similar to those of the direction in which the positive electrode lead 31 is led. Details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. Specifically, the sealing film 41 includes a polymer compound such as a polyolefin that has adherence to the positive electrode lead 31. Specific examples of the polyolefin include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below upon charging and discharging.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon charging and discharging, lithium is inserted and extracted in an ionic state.

To manufacture the secondary battery, the positive electrode 21 and the negative electrode 22 are fabricated and the electrolytic solution is prepared, following which the secondary battery is assembled using the positive electrode 21, the negative electrode 22, and the electrolytic solution, and the assembled secondary battery is subjected to a stabilization process, in accordance with an example procedure described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B may be compression-molded by means of, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is fabricated by a procedure substantially similar to the fabrication procedure of the positive electrode 21 described above. Specifically, a mixture (a negative electrode mixture) in which the negative electrode active material, the negative electrode binder, and the negative electrode conductor are mixed with each other is put into a solvent to thereby prepare a negative electrode mixture slurry in paste form, following which the negative electrode mixture slurry is applied on the two opposed surfaces of the negative electrode current collector 22A to thereby form the negative electrode active material layers 22B. Thereafter, the negative electrode active material layers 22B may be compression-molded by means of, for example, a roll pressing machine. The negative electrode active material layers 22B are thus formed on the two respective opposed surfaces of the negative electrode current collector 22A. As a result, the negative electrode 22 is fabricated.

The electrolyte salt is put into the solvent. The electrolyte salt is thereby dispersed or dissolved in the solvent. The electrolytic solution is thus prepared.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by the joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). Thereafter, the wound body is pressed by means of, for example, a pressing machine to thereby shape the wound body into an elongated shape. The shaped wound body has a configuration similar to that of the battery device 20 except that the positive electrode 21, the negative electrode 22, and the separator 23 are not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20, i.e., the wound electrode body, is fabricated, and the battery device 20 is sealed in the outer package film 10 having the pouch shape. As a result, the secondary battery is assembled.

The assembled secondary battery is charged and discharged. Conditions including, for example, an environment temperature, the number of times of charging and discharging (the number of cycles), and charging and discharging conditions may be set as desired. As a result, a film is formed on each of the surface of the positive electrode 21 and the surface of the negative electrode 22, which electrochemically stabilizes a state of the battery device 20. The secondary battery is thus completed.

According to the above-described secondary battery, the positive electrode 21 includes the positive electrode active material, and the positive electrode active material has a configuration similar to that of the positive electrode active material 100. Accordingly, for the above-described reasons, a high battery capacity is obtainable, and an increase in electrical resistance and a decrease in discharge capacity are suppressed even if the secondary battery is repeatedly charged and discharged. As a result, it is possible to achieve a superior battery characteristic.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the positive electrode active material 100.

Next, a description is given of modification examples of the above-described secondary battery according to an embodiment.

The configuration of the secondary battery is appropriately modifiable as described below. Note that any of the following series of modification examples may be combined with each other.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves, which suppresses winding displacement of the battery device 20. This suppresses swelling of the secondary battery even if the decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may each include insulating particles. One reason for this is that the insulating particles promote heat dissipation upon heat generation by the secondary battery, thus improving safety or heat resistance of the secondary battery. The insulating particles include any one or more of materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

To fabricate the separator of the stacked type, a precursor solution including the polymer compound and a solvent is prepared, following which the precursor solution is applied on one of or each of the two opposed surfaces of the porous film. In this case, the porous film may be immersed in the precursor solution instead of applying the precursor solution on the porous film. The insulating particles may be added to the precursor solution.

When the separator of the stacked type is used also, lithium is movable between the positive electrode 21 and the negative electrode 22, and similar effects are therefore achievable. In this case, in particular, the secondary battery improves in safety, as described above. Accordingly, it is possible to achieve higher effects.

The electrolytic solution that is a liquid electrolyte is used. However, although not specifically illustrated here, an electrolyte layer, which is a gel electrolyte, may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

The electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. To form the electrolyte layer, a precursor solution including the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using home appliances.

An application example of the secondary battery will now be described in detail. The configuration described below is merely an example, and is appropriately modifiable.

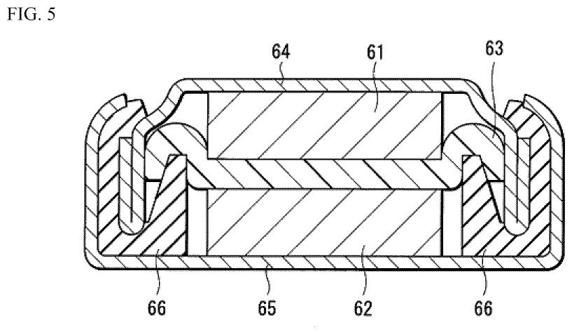

FIG. 4 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to an external power source via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes a central processing unit (CPU) and a memory, and controls an operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Experiment Examples 1 to 8 and Comparative Examples 1 to 5

Secondary batteries were fabricated, following which the secondary batteries were each evaluated for its characteristic.

### [Fabrication of Secondary Battery]

FIG. 5 illustrates a sectional configuration of a test secondary battery. The test secondary battery was a secondary battery (a lithium-ion secondary battery) of what is called a coin type.

As illustrated in FIG. 5, the secondary battery included a test electrode 61, a counter electrode 62, a separator 63, an outer package cup 64, an outer package can 65, a gasket 66, and an electrolytic solution (not illustrated).

The test electrode 61 was placed inside the outer package cup 64, and the counter electrode 62 was placed inside the outer package can 65. The test electrode 61 and the counter electrode 62 were stacked on each other with the separator 63 interposed therebetween. The test electrode 61, the counter electrode 62, and the separator 63 were impregnated with the electrolytic solution. The outer package cup 64 and the outer package can 65 were crimped to each other with the gasket 66 interposed therebetween. The test electrode 61, the counter electrode 62, and the separator 63 were each thus sealed in the outer package cup 64 and the outer package can 65.

Here, to simply evaluate the battery characteristic, the secondary batteries of the coin type illustrated in FIG. 5 were fabricated in accordance with the following procedure.

### [Fabrication of Test Electrode]

First, a raw material was prepared.

To form the covering material including, as a constituent element, titanium as the second additional metal element, Ni_{1.98}Ti_{0.02}CO₃ having purity of 99% and Ni_{1.50}Ti_{0.50}CO₃ having purity of 99% were used as the raw materials. To form the covering material including, as a constituent element, platinum as the second additional metal element, Ni_{1.50}Pt_{0.50}CO₃ having purity of 99% was used as the raw material. To form the covering material including, as a constituent element, copper as the second additional metal element, Ni_{1.50}Cu_{0.50}CO₃ having purity of 99% was used as the raw material. To form the covering material including, as a constituent element, tungsten as the second additional metal element, Ni_{1.50}W_{0.50}CO₃ having purity of 99% was used as the raw material. To form the covering material including no second additional metal element, as a constituent element, Ni₂CO₃ having purity of 99% was used as the raw material.

Thereafter, the raw material was fired (at a firing temperature of 400° for a firing time of 10 hours) to thereby form a precursor body.

When Ni_{1.98}Ti_{0.02}CO₃ was used as the raw material, Ni_{0.99}Ti_{0.01}O was formed as the precursor body. When Ni_{1.50}Ti_{0.50}CO₃ was used as the raw material, Ni_{0.75}Ti_{0.25}O was formed as the precursor body. When Ni_{1.50}Pt_{0.50}CO₃ was used as the raw material, Ni_{0.75}Pt_{0.25}O was formed as the precursor body. When Ni_{1.50}Cu_{0.50}CO₃ was used as the raw material, Ni_{0.75}Cu_{0.25}O was formed as the precursor body. When Ni_{1.50}W_{0.50}CO₃ was used as the raw material, Ni_{0.75}W_{0.25}O was formed as the precursor body. When Ni₂CO₃ was used as the raw material, NiO was formed as the precursor body.

Thereafter, the precursor body and a lithium compound (lithium oxide (Li₂O) having purity of 99.5%) were mixed with each other to thereby obtain a mixture, following which the mixture was fired (at a firing time of 650° C. and for a firing time of 24 hours) to obtain a fired material.

When Ni_{0.99}Ti_{0.01}O was used as the precursor body, Li₂Ni_{0.99}Ti_{0.01}O₂ was formed as the fired material. When Ni_{0.75}Ti_{0.25}O was used as the precursor body, Li₂Ni_{0.75}Ti_{0.25}O₂ was formed as the fired material. When Ni_{0.75}Pt_{0.25}O was used as the precursor body, Li₂Ni_{0.75}Pt_{0.25}O₂ was formed as the fired material. When Ni_{0.75}Cu_{0.25}O was used as the precursor body, Li₂Cu_{0.75}Pt_{0.25}O₂ was formed as the fired material. When Ni_{0.75}W_{0.25}O was used as the precursor body, Li₂Ni_{0.75}W_{0.25}O₂ was formed as the fired material. When NiO was used as the precursor body, Li₂NiO₂ was formed as the fired material.

Thereafter, the fired material was pulverized with a mortar to thereby obtain a pulverized material, following which coarse particles were removed from the pulverized material with a sieve (having a mesh size of 90 μm). The covering material in powder form was thus obtained.

Thereafter, the center parts 110 (the first lithium composite oxide having the layered rock-salt crystal structure) in powder form were prepared. Used as the first lithium composite oxide was Li_{1.02}Ni_{0.90}Co_{0.05}Al_{0.05}O₂ (NCA).

Thereafter, the center parts 110 and the covering material were put in a centrifugal fluidized granulator, following which granulation was performed by the centrifugal fluidized granulator. In this case, an amount of the central parts 110 to be put in was set to 1 kg, an amount of the covering material to be put in was set to 45 g, an air volume was set to 0.1 m³/min, an inlet air temperature was set to 60° C., an exhaust air temperature was set to 40° C., a rotation number was set to 150 minutes, and a coating time was set to 20 minutes.

The covering material was thereby fixed to the surface of each of the center parts 110, and the covering part 120 (the second lithium composite oxide having the orthorhombic crystal structure represented by the space group Immm) was thus formed. Accordingly, the positive electrode active material 100 in powder form, i.e., the multiple positive electrode active materials 100 each including the center part 110 and the covering part 120 were obtained.

The completed positive electrode active material 100 was analyzed to check the composition and the crystal structure of the center part 110 and the composition and the crystal structure of the covering part 120, which resulted as presented in Table 1. Note that details of the procedure for analyzing the positive electrode active material 100 were as described above.

To manufacture the positive electrode active material 100, the average covering amount (mmol/m²) of the covering part 120 was changed by changing the mixture ratio between the precursor body and the lithium compound. After the completion of the positive electrode active material 100, the average covering amount was checked, which resulted as presented in Table 1. Details of the procedure for calculating the average covering amount were as described above.

Thereafter, the positive electrode active materials 100, the positive electrode binder (polyvinylidene difluoride), and the positive electrode conductor (graphite) were mixed with each other to thereby obtain a positive electrode mixture. In this case, a mixture ratio (a weight ratio) between the positive electrode active materials 100, the positive electrode binder, and the positive electrode conductor was set to 96:2:2.

Thereafter, the positive electrode mixture was put into a solvent (N-methyl-2-pyrrolidone as an organic solvent), following which the solvent was stirred to thereby prepare a positive electrode mixture slurry in paste form. Thereafter, the positive electrode mixture slurry was applied on one of the two opposed surfaces of the positive electrode current collector 21A (an aluminum foil having a thickness of 15 μm) by means of a coating apparatus, following which the applied positive electrode mixture slurry was dried to thereby form the positive electrode active material layer 21B.

Thereafter, the positive electrode active material layer 21B was compression-molded by means of a roll pressing machine. In this case, an area density of the positive electrode active material layer 21B was set to 18 mg/cm². Lastly, the positive electrode current collector 21A with the positive electrode active material layer 21B formed thereon was cut into a disk shape (having a diameter of 16 mm). The test electrode 61 including the positive electrode current collector 21A and the positive electrode active material layer 21B was thus fabricated.

The test electrode 61 for comparison was fabricated by a similar procedure except that the covering part 120 was not formed.

In addition, the test electrode 61 for comparison was fabricated by a similar procedure except that another compound was used instead of the second lithium composite oxide. Used as the other compounds were Li₂CoO₂ having a trigonal crystal structure represented by space group P-3m, Li₂CoO₂ having an orthorhombic crystal structure represented by space group Immmm, Li₂NiO₃ having an orthorhombic crystal structure represented by space group C2/m, and NiO having a cubic crystal structure represented by space group Fm-3m, as indicated in Table 1.

### [Preparation of Counter Electrode]

Used as the counter electrode 62 was a disk-shaped lithium metal plate (having a thickness of 0.24 mm and a diameter of 17 mm).

### [Preparation of Electrolytic Solution]

The electrolyte salt (lithium hexafluorophosphate (LiPF₆) as a lithium salt) was added to the solvent (ethylene carbonate as a cyclic carbonic acid ester and ethyl methyl carbonate as a chain ethylene carbonate), following which the solvent was stirred. In this case, a mixture ratio (a mass ratio) between ethylene carbonate and ethyl methyl carbonate in the solvent was set to 30:70, and a content of the electrolyte salt was set to 1 mol/l (=1 mol/dm³) with respect to the solvent. The electrolytic solution was thus prepared.

### [Assembly of Secondary Battery]

First, the test electrode 61 was placed in the outer package cup 64 (SUS304 having a thickness of 200 μm), and the counter electrode 62 was placed in the outer package can 65 (SUS304 having a thickness of 200 μm). Thereafter, the test electrode 61 placed in the outer package cup 64 and the counter electrode 62 placed in the outer package can 65 were stacked on each other with the disk-shaped separator 63 (a microporous polyethylene film having a thickness of 15 μm and a diameter of 17.5 mm), impregnated with the electrolytic solution, interposed therebetween. In this case, the positive electrode active material layer 21B and the negative electrode active material layer 22B were opposed to each other with the separator 63 interposed therebetween. Lastly, the outer package cup 64 and the outer package can 65 were crimped to each other with the gasket 66 (a polypropylene film having a thickness of 0.3 mm) interposed therebetween, in a state in which the test electrode 61 and the counter electrode 62 were stacked on each other with the separator 63 interposed therebetween. Accordingly, the test electrode 61 and the counter electrode 62 were sealed in the outer package cup 64 and the outer package can 65. The secondary battery was thus assembled.

### [Stabilization of Secondary Battery]

First, the secondary battery was charged in an ambient temperature environment (at a temperature of 25° C.). Upon charging, the secondary battery was charged with a constant current of 0.1 C until a voltage reached 4.25 V, and was thereafter charged with a constant voltage of that value, 4.25 V, until a current reached 0.005 C. Note that 0.1 C was a value of a current that caused a battery capacity (a theoretical capacity) to be completely discharged in 10 hours, and 0.005 C was a value of a current that caused the battery capacity to be completely discharged in 20 hours.

Thereafter, the charged secondary battery was left standing (for a standing time of 10 minutes) in the same environment.

Lastly, the secondary battery was discharged in the same environment. Upon discharging, the secondary battery was discharged with a constant current of 0.1 C until the voltage reached 2.0 V.

A film was thus formed on the surface of each of the test electrode 61 and the counter electrode 62, and the state of the secondary battery was therefore electrochemically stabilized. The secondary battery was thus completed.

### [Evaluation of Battery Characteristic]

The secondary batteries were each evaluated for a cyclability characteristic and an electrical resistance characteristic as the battery characteristic in accordance with the following procedure, and the evaluation revealed the results presented in Table 1.

### [Cyclability Characteristic]

First, the secondary battery was charged and discharged in a thermostatic chamber (at a temperature of 60° C.) to thereby measure a discharge capacity (a first-cycle discharge capacity). In this case, used was the secondary battery that had been in a state of not being charged or discharged for three hours or more before the foregoing charging and discharging. Thereafter, the secondary battery was repeatedly charged and discharged in the same environment until the number of cycles reached 100 to thereby measure the discharge capacity (a 100th-cycle discharge capacity). Lastly, a capacity retention rate that served as an index for evaluating the cyclability characteristic was calculated based on the following calculation expression: capacity retention rate (%)=(100th-cycle discharge capacity/first-cycle discharge capacity)×100.

The charging and discharging conditions for the first cycle were as described below. That is, to evaluate the cyclability characteristic, a process of charging and discharging the secondary battery, based on the following charging and discharging conditions, was repeated 100 times.

First, the secondary battery was charged. In this case, the secondary battery was charged with a constant current of 1 C until a voltage reached 4.25 V, and was thereafter charged with a constant voltage of that value, 4.25 V, until a current reached 0.01 C. Note that 1 C was a value of a current that caused the battery capacity to be completely discharged in one hour, and 0.01 C was a value of a current that caused the battery capacity to be completely discharged in 100 hours.

Thereafter, the charged secondary battery was left standing (for a standing time of one minute) to thereby stop the charging of the secondary battery.

Thereafter, the charged secondary battery was discharged. In this case, the secondary battery was discharged with a constant current of 5 C until the voltage reached 2.5 V. Note that 5 C was a value of a current that caused the battery capacity to be completely discharged in 0.2 hours.

Lastly, the discharged secondary battery was left standing (for a standing time of five minutes) to thereby stop the discharging of the secondary battery.

Note that values of the capacity retention rate given in Table 1 were values normalized with respect to the value of the capacity retention rate of a case where the covering part 120 was not formed (Comparative example 1) assumed to be 100.

### [Electrical Resistance Characteristic]

First, the secondary battery was charged and discharged for 100 cycles in a thermostat chamber (at a temperature of 25° C.), following which an electrochemical impedance (EIS) of the test electrode 61 was measured by an alternating-current impedance measurement method. An electrical resistance (Ω) of the test electrode 61 that served as an index for evaluating the electrical resistance characteristic was thereby calculated based on a measurement result of the EIS. In this case, a semicircular component within a range of frequency from 500 Hz to 1 Hz both inclusive was used as the electrical resistance of the test electrode 61. Charging and discharging conditions were set to be similar to the charging and discharging conditions for the above-described evaluation of the cyclability characteristic.

Used as an EIS measurement apparatus was a multi-channel potentiostat VMP-3 available from Bio-Logic Science Instruments. As measurement conditions, a frequency range was set to a range from 1 MHz to 0.1 Hz both inclusive, and an alternating-current amplitude was set to 10 mV.

Note that values of the electrical resistance given in Table 1 were values normalized with respect to the value of the electrical resistance of the case where the covering part 120 was not formed (Comparative example 1) assumed to be 100.

TABLE 1

| | Center part | | Covering part | | | Covering | Capacity | Electrical |
|---|---|---|---|---|---|---|---|---|
| | First lithium | | Second lithium | Other | Crystal structure | amount | retention rate | resistance |
| | composite oxide | Crystal structure | composite oxide | compound | (Space group) | (mmol/m²) | (Normalized) | (Normalized) |
| Example 1 | NCA | Layered rock-salt | Li₂Ni_{0.99}Ti_{0.01}O₂ | — | Immm | 0.01 | 117 | 69 |
| Example 2 | NCA | Layered rock-salt | Li₂Ni_{0.99}Ti_{0.01}O₂ | — | Immm | 0.03 | 128 | 50 |
| Example 3 | NCA | Layered rock-salt | Li₂Ni_{0.99}Ti_{0.01}O₂ | — | Immm | 0.05 | 128 | 53 |
| Example 4 | NCA | Layered rock-salt | Li₂Ni_{0.75}Ti_{0.25}O₂ | — | Immm | 0.05 | 130 | 52 |
| Example 5 | NCA | Layered rock-salt | Li₂Ni_{0.75}Pt_{0.25}O₂ | — | Immm | 0.05 | 131 | 49 |
| Example 6 | NCA | Layered rock-salt | Li₂Ni_{0.75}Cu_{0.25}O₂ | — | Immm | 0.05 | 137 | 54 |
| Example 7 | NCA | Layered rock-salt | Li₂Ni_{0.75}W_{0.25}O₂ | — | Immm | 0.05 | 123 | 51 |
| Example 8 | NCA | Layered rock-salt | Li₂NiO₂ | — | Immm | 0.05 | 125 | 72 |
| Comparative | NCA | Layered rock-salt | — | — | | — | 100 | 100 |
| example 1 | | | | | | | | |
| Comparative | NCA | Layered rock-salt | — | Li₂CoO₂ | P-3m | 0.05 | 107 | 84 |
| example 2 | | | | | | | | |
| Comparative | NCA | Layered rock-salt | — | Li₂CoO₂ | Immm | 0.05 | 111 | 81 |
| example 3 | | | | | | | | |
| Comparative | NCA | Layered rock-salt | — | Li₂NiO₃ | C2/m | 0.05 | 110 | 89 |
| example 4 | | | | | | | | |
| Comparative | NCA | Layered rock-salt | — | NiO | Fm-3m | 0.05 | 107 | 100 |
| example 5 | | | | | | | | |

As indicated in Table 1, the capacity retention rate and the electrical resistance varied greatly depending on the configuration of the positive electrode active material 100. In the following, used as comparison references were the capacity retention rate and the electrical resistance of the case where the covering part 120 was not formed (Comparative example 1).

Specifically, when the positive electrode active material 100 included the center part 110 and the covering part 120, but the covering part 120 included the other compound (Comparative examples 2 to 5), the capacity retention rate slightly increased, and the electrical resistance slightly decreased in some cases.

In contrast, when the positive electrode active material 100 included the center part 110 and the covering part 120, and the covering part 120 included the second lithium composite oxide (Examples 1 to 8), the capacity retention rate greatly increased, and the electrical resistance greatly decreased.

In particular, when the covering part 120 included the second lithium composite oxide (Examples 1 to 8), the following tendencies were observed.

Firstly, when the center part 110 included the first lithium composite oxide, the capacity retention rate sufficiently increased, and the electrical resistance sufficiently decreased.

Secondly, when the average covering amount of the covering part 120 was within the range from 0.01 mmol/m² to 0.05 mmol/m² both inclusive, the capacity retention rate sufficiently increased, and the electrical resistance sufficiently decreased.

Based on the results presented in Table 1, when: the positive electrode active material 100 included the center part 110 and the covering part 120; the center part 110 included the first lithium composite oxide having the layered rock-salt crystal structure; and the covering part 120 had the orthorhombic crystal structure represented by the space group Immm and included nickel as a constituent element, the capacity retention rate greatly increased, and the electrical resistance greatly decreased. The cyclability characteristic and the electrical resistance characteristic were thus improved. Accordingly, it was possible to obtain a secondary battery having a superior battery characteristic.

Although the present technology has been described according to an embodiment including Examples, the configuration of the present technology is not limited thereto, and is therefore modifiable in a variety of ways.

For example, the description has been given of the case where the secondary battery has a battery structure of the laminated-film type or the coin type. However, the battery structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and the device structure may be, for example, a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited in kind. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode including a positive electrode active material;
a negative electrode; and
an electrolytic solution, in which
the positive electrode active material includes
   a center part, and
   a covering part covering a surface of the center part,
the center part includes a first lithium composite oxide having a layered rock-salt crystal structure, and
the covering part includes a second lithium composite oxide, the second lithium composite oxide having an orthorhombic crystal structure represented by space group Immm and including nickel as a constituent element.
   <2>

The secondary battery according to <1>, in which the second lithium composite oxide includes a compound represented by Formula (1),

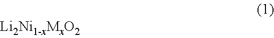

where
M includes at least one of Ti, Pt, Cu, or W, and
x satisfies 0≤x≤0.25.
   <3>

The secondary battery according to <2>, in which M in Formula (1) includes Cu, W, or both, or includes at least one of Ti, Pt, or Cu.

<4>

The secondary battery according to any one of <1>to <3>, in which an average covering amount of the covering part is greater than or equal to 0.01 millimoles per square meters and less than or equal to 0.05 millimoles per square meters.

<5>

The secondary battery according to any one of <1>to <4>, in which the secondary battery includes a lithium-ion secondary battery.

<6>

A positive electrode for a secondary battery, the positive electrode including
a positive electrode active material, in which
the positive electrode active material includes
   a center part, and
   a covering part covering a surface of the center part,
the center part includes a first lithium composite oxide having a layered rock-salt crystal structure, and
the covering part includes a second lithium composite oxide, the second lithium composite oxide having an orthorhombic crystal structure represented by space group Immm and including nickel as a constituent element.
   <7>

A positive electrode active material for a secondary battery, the positive electrode active material including:
a center part; and
a covering part covering a surface of the center part, in which
the center part includes a first lithium composite oxide having a layered rock-salt crystal structure, and
the covering part includes a second lithium composite oxide, the second lithium composite oxide having an orthorhombic crystal structure represented by space group Immm and including nickel as a constituent element.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material;
a negative electrode; and
an electrolytic solution, wherein
the positive electrode active material includes
a center part, and
a covering part covering a surface of the center part,
the center part includes a first lithium composite oxide having a layered rock-salt crystal structure, and
the covering part includes a second lithium composite oxide, the second lithium composite oxide having an orthorhombic crystal structure represented by space group Immm and including nickel as a constituent element.

2. The secondary battery according to claim 1, wherein the second lithium composite oxide includes a compound represented by Formula (1), 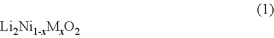
where
M includes at least one of Ti, Pt, Cu, or W, and
x satisfies 0≤x≤0.25.

3. The secondary battery according to claim 2, wherein M in Formula (1) includes Cu, W, or both, or includes at least one of Ti, Pt, or Cu.

4. The secondary battery according to claim 1, wherein an average covering amount of the covering part is greater than or equal to 0.01 millimoles per square meters and less than or equal to 0.05 millimoles per square meters.

5. The secondary battery according to claim 1, wherein the secondary battery comprises a lithium-ion secondary battery.

6. A positive electrode for a secondary battery, the positive electrode comprising
a positive electrode active material, wherein
the positive electrode active material includes
a center part, and
a covering part covering a surface of the center part,
the center part includes a first lithium composite oxide having a layered rock-salt crystal structure, and
the covering part includes a second lithium composite oxide, the second lithium composite oxide having an orthorhombic crystal structure represented by space group Immm and including nickel as a constituent element.

7. A positive electrode active material for a secondary battery, the positive electrode active material comprising:
a center part; and
a covering part covering a surface of the center part, wherein
the center part includes a first lithium composite oxide having a layered rock-salt crystal structure, and
the covering part includes a second lithium composite oxide, the second lithium composite oxide having an orthorhombic crystal structure represented by space group Immm and including nickel as a constituent element.
